(19) United States
(12) Patent Application Publication
(10) Pub. No.: US 2001/0006399 A1
(43) Pub. Date: Jul. 5, 2001

(54) Laser marking method and laser marker for carrying out the method

(76) Inventor: Teiichirou Chiba, Kanagawa-ken (JP)

Correspondence Address: Michael S. Leonard, Bell, Boyd & Lloyd, Three First National Plaza, 70 West Madison Street, Suite 3300, Chicago, IL, 60602-4207, US

(21) Appl. No.: 09/735,456

(22) Filed: Dec. 12, 2000

(30) Foreign Application Priority Data
Dec. 24, 1999 (JP) P11-366647

(51) Int. Cl. B41J 2/435

(52) U.S. Cl. 347/224

(57) ABSTRACT

In a laser marking method of irradiating laser beam onto a display area of a pattern display device and marking a required marking pattern on a surface of an objective article for being marked through a required display pattern displayed on the irradiated display area, a distance P between centers of adjacent dot marks formed collectively on a marking surface of the objective article for being marked is set such that, when dimensions of the dot marks in a matrix direction are set to be D1 and D2, and a gap between the dot marks adjacent in the matrix direction is G, the equation P≧{(D1+G)²+(D2+G)²}^{½}(here, G≧0) can be satisfied. As a result, the adjacent dot marks are not fused to each other at the time of dot marking, and the dot marks are formed orderly with their shapes being maintained. Thus, the marking pattern can be marked accurately without gaps between the dots being fused, optical visibility of the marking pattern can be improved, and efficient marking can be realized.

### BACKGROUND OF THE INVENTION

1. Field of the Invention

The present invention relates to a laser marking method and a laser marker for carrying out the method. More particularly, it relates to a laser marking method and a laser marker in which a marking pattern is formed by a of laser beam for purposes of product management, various security and the like, and fusion of the dot-shaped marks adjacent in a matrix direction does not occur so that optical visibility is improved.

2. Description of the Related Art

In a semiconductor manufacturing process, for example, it is necessary to set various and strict manufacturing conditions for each of the semiconductor manufacturing steps. In order to manage products, various security and the like, a marking pattern for information that is composed of numbers, characters or symbols is displayed with dots in a matrix on a part of a surface of a semiconductor wafer.

As a workpiece such as a semiconductor product has been smaller recently, a marking area of a semiconductor wafer is limited to an extremely narrower area. Thus, the pattern to be marked is required to be fine and accurate.

This marking is, as shown in FIGS. 11 to 13, normally carried out by irradiating continuous pulse laser beam, via an optical system, onto a part of a surface of a semiconductor wafer 4 as an objective article for being marked. As shown in FIG. 11, a laser marker 1 irradiates laser beam from a laser oscillator 3 onto an irradiation area of a liquid crystal mask 2 as a pattern display device, which is performed by batch irradiation or raster scanning. Then, the laser beam transmits a required display pattern 5 displayed on the irradiation area of the liquid crystal mask 2, whereby a required marking pattern is marked on the surface of the semiconductor wafer 4 via a lens unit 6.

A control unit 8 controls operations of the laser oscillator 3, the liquid crystal mask 2, the lens unit 6 that images the transmitted beam of the liquid crystal mask 2 on the surface of the semiconductor wafer 4 in dots, a carrier device 7 for carrying the semiconductor wafer 4, an optical system element (not shown) and the others.

The control unit 8 outputs control signals to the devices 2, 3, 7 and the others according to instructions of a main program of a computer system (not shown).

Liquid crystals as pattern display drivers are arranged in a matrix on the irradiation area of the liquid crystal mask 2, and a transmissible or non-transmissible required display pattern 5 is driven to be displayed. A required pattern is driven to be displayed by driving and controlling individual the arbitrary liquid crystals of the liquid crystal mask based on the control unit 8. The liquid crystal mask 2 is a transmission-type liquid crystal device in which liquid crystals to which voltage is not applied is in a light reflecting state and liquid crystals to which voltage is applied is in a light transmissible state. The mask 2 as the transmission-type liquid crystal device is composed of liquid crystals which are arranged in a dot matrix composed of a predetermined number of dots. The required display pattern 5 is selected by a computer system (not shown). This selection can also be carried out by an external operation.

As being widely known, the liquid crystal mask 2 can drive and display a light transmitting section and a non-light transmitting section in each liquid crystal unit according to the required display pattern 5. This liquid crystal mask 2 is provided in such a manner that a plurality of parallel electrode lines cross each other between front and rear surfaces of the liquid crystals, and voltage according to a marking pattern is applied to the respective element electrodes. The laser beam transmits the respective liquid crystal portions in the light transmissible state in the pattern irradiation area. As a result, a required marking pattern is formed on the surface of the objective article 4 for being marked.

The required marking pattern to be marked on the surface of the semiconductor wafer 4 is stored, as dot information, in a predetermined address group in a memory of the control unit 8. According to the dot information, for example, the light reflecting portion (non-marking portion) is converted into “0” and the light transmitting portion (marking portion) is converted into “1”. This control unit 8 processes required dot information based on instructions of a main program of the microcomputer (not shown).

As a result, predetermined voltage is applied to a predetermined voltage-application portion of the liquid crystal mask 2, whereby the required display pattern 5 is displayed by dots on the display mask 2. In an example shown in FIG. 14, the irradiation area of the pattern display drivers is composed of non-marking portions 16 and marking portions 17, which are dot matrixed liquid crystals of (3 to 7) dots × (6 or 7) dots per a single mark. The display area of the liquid mask 5 is batch-irradiated or raster-scanned with the laser beam from the laser oscillator 3 in accordance with the display pattern 5, based on the instructions of the control unit 8, whereby a required marking pattern 18 is marked on the surface of the semiconductor wafer 4, as shown in FIG. 15.

As shown in FIG. 12, a laser marker 9 uses a multi-mirror module such as a so-called DMD (Digital Micromirror Device). A laser marker 11 shown in FIG. 13 uses an acoust-optic element 12 as a deflecting element for driving and controlling elements. A required display pattern is driven and controlled in an irradiation area of the liquid crystal mask which is irradiated by the multi-mirror module 10 and the acoust-optic element 12. A required marking pattern composed of many dot marks is marked on the surface of the wafer 4 according to the display pattern by the irradiation of the laser beam from the laser oscillator 3.

Similarly to FIG. 11, the above operations are controlled by a control unit (not shown) according to an instruction of a main program of a microcomputer (not shown). This control unit performs operations of the respective devices based on the dot information that are converted as the marking portions and the non-marking portions in the irradiation area of the required pattern display drivers. The multi-mirror module 10 and the acoust-optic element 12 serve as a kind of pattern display device based on the dot information. On a laser optical axis of the laser markers 1, 9 and 11 shown in FIGS. 11 to 13, an optical member utilizing diffraction phenomenon, an optical member utilizing reflecting phenomenon or an optical member utilizing refraction phenomenon is arranged. Here, in FIG. 12, reference numeral 13 is a laser absorption plate and 14 is a mirror. In FIG. 13, reference numeral 15 is an f-θ lens.

As a general laser marker utilizing laser beam, for example, Japanese Patent Application Publication No. 2-205281 discloses a laser marker that irradiates a pulse laser beam of comparatively small energy to one point repeatedly. In this marking method, the first laser pulse irradiation is carried out with a frequency of not more than 1 KHz, and a frequency of the thereafter laser pulse is 2 to 5 KHz that is a high-repetition frequency. As a result, dots with depth of 0.5 to 1.0 μm or 1.0 to 1.5 μm are formed.

According to this kind of the dot marking method, character input for printing on a semiconductor wafer and a marking pattern are set in an input section. A marker controller controls an optical system element in order to mark dots with predetermined depth on the wafer according to the set marking pattern, and carries out marking with one-time Q switch pulse for one dot. Moreover, Japanese Patent Application Publication No. 9-206965 discloses a laser marker in which a mirror control section controls a plurality of movable mirrors arranged two-dimensionally in a matrix based on electric signals of a pattern instruction section so as to irradiate laser beam onto a surface of an objective article for being marked.

As to the semiconductor wafers on which dots are marked according to these conventional marking methods, the marking patterns of dots are read so that information such as production management is managed for each wafer. As described in Japanese Patent Application Publication No. 2-299216, this marking pattern of dots is read from change in reflectance due to irradiation of laser beam of an He-Ne laser or change in oscillation of heat wave of normal laser beam, and then various manufacturing conditions in the subsequent manufacturing steps are set based on the read information.

Therefore, in case where the reading is not carried out accurately and false information is read, all products would become defective. The faulty reading is due to unclearness of a dot pitch of the marking pattern obtained by dot marking. One factor of this unclearness is in that a whole shape of the marking pattern is distorted. A dot, which is formed by irradiation of reduced image of laser beam onto an irradiation point of a surface of the semiconductor wafer, has a great energy at its center portion. When adjacent dots are in a fused state, the dots are influenced greatly by thermal diffusion due to thermal energy obtained by strong heat conduction to the peripheries. As a result, gaps between the dots are also fused so that the dots are joined to each other. Therefore, it is necessary to avoid the gaps between the dots to be fused by such diffusion of the thermal energy.

In the marking on the semiconductor wafer, if an area for one character is set to be within 200 μm and the pitch of the dot marks is set to be within 15 μm, a number of dots composing one character would be suppressed minimally. According to this marking, fine dot marks are arranged in an arbitrary position in a matrix direction in an extremely narrow area to form a required pattern. Thus, the gaps between the dots for forming the marking pattern and their peripheries tend to be heated and be in a state that thermal diffusion easily occurs.

Therefore, when the heat of the insides of the dots and their peripheral wall portions are difficult to be dispersed, thermal energy diffusion due to thermal conduction greatly influences. As a result, heating and fusing from the respective dots are diffused in a synergism way. In case where, for example, a frequency (Qsw frequency) of a laser pulse is at least not less than about 100 kHz, the marking tends to be influenced by thermal diffusion easily when a minimum gap between the dots is not more than about ⅕of 1 dot size. However, the occurrence of the fusion does not depend only on the gaps between the dots.

As mentioned above, since the dot mark has a great energy at its center portion, great thermal diffusion tends to occur due to thermal conduction to the peripheral walls of the dot mark, and the gaps between the adjacent dot marks are fused so that the dot marks may be easily fused. For this reason, as shown in FIG. 16, gaps between the adjacent dot marks 18 are fused, so that the respective shapes of the dot marks are distorted and dimension of their heights becomes small. Furthermore, efficient fusion process cannot be executed.

When the peripheral portions and the like of the dot marks are fused to each other due to thermal conduction, the reading can be carried out accurately, so that existence/non-existence of the dot marks can not be read or can be misread. For example, as shown in FIG. 16D, an outline of an approximately L-shaped portion on the outer periphery of the marking pattern may be recognized, but a dot marks in alignment on the opposite side cannot be recognized. Thus, the position of a dot mark, a direction of the marking pattern and the like cannot be recognized. Therefore, various manufacturing conditions, qualities and the like in the subsequent manufacturing steps are influenced greatly based on the read information.

Meanwhile, it can be considered that a surface of a semiconductor wafer is fused in a spotted state by irradiation of laser beam with comparative small energy so that a fine dot pattern is marked in an extremely narrow area of the semiconductor wafer. However, with this method, a dot shape is unstabilized, and a marking speed of the marking pattern becomes slow, thus yield of products is not satisfactory.

Furthermore, it can be considered that after a predetermined time is taken for dots to be cooled completely, a surface of a semiconductor wafer is fused in a spotted state according the next pattern so that dot marks are marked. However, with this method, considerably long time is required for marking all the whole dot pattern, so that productivity is lowered.

Japanese Patent Application Publication Nos. 2-205281 and 9-206965 do not describe any of the above-mentioned technical problems. Therefore, it is apparent that the laser marking as disclosed in these publications does not aim to form a whole fine marking pattern in an extremely narrow area without being influenced by thermal conduction.

### SUMMARY OF THE INVENTION

The present invention is made in order to solve the above problems. Specifically, it is an object of the present invention to provide a laser marking method and a laser marker using the laser marker in which a marking pattern with excellent optical visibility can be formed accurately and efficiently, peculiar cooling time is not required, gaps between adjacent dots are not fused, and existence/non-existence of dots can be accurately recognized.

The inventors of the present invention studied solutions of the above problems in various aspects, and came to a deduction that defects due to fusion may be avoided securely if a pitch between dot marks is enlarged in such a manner that the dot marks are prevented from being influenced by reserved thermal energy applied to the adjacent dot marks at the time of irradiation of laser beam. However, if a lot of information is intended to be marked on a limited marking area, a pitch between the dot marks should be necessarily as small as possible.

Then, further examination and experiment were repeated, and it was found that a minimum dimension of a distance between centers of the respective dots can be determined uniformly based on dimensions of the dot marks so as not to cause fusion between the adjacent dot marks, regardless of shapes and actual dimensions of dot marks. According to the present invention, there is provided a laser marking by controlling so as not to cause fusion between adjacent dot marks on a basis of minimum dimension of a distance between centers of the adjacent dot marks.

In other words, according to a first aspect of the present invention, there is provided a laser marking method for marking a required marking pattern on a surface of an objective article for being marked by means of a laser marker, characterized by including a step of setting a distance P between centers of dot marks to be marked collectively such that, when dimensions of each of the dot marks in a matrix direction are set to be D1 and D2 respectively, and a gap between the dot marks adjacent in the matrix direction is G, the following equation is satisfied:

P≧{(D1+G)²+(D2+G)²}^{½}

here, G≧0. Moreover, according to a second aspect of the present invention, there is provided a laser marker suitable for carrying out the above laser marking method.

Specifically, the laser marker drives a plurality of pattern display drivers, irradiates laser beam onto a display area of a pattern display device on which a desired display pattern is displayed, and irradiates the laser beam onto a marking area of an objective article for being marked via the pattern display device and an optical system so as to mark a desired marking pattern formed of a plurality of dot marks arranged in a matrix direction. The laser marker is characterized by including setting means for setting a distance P between centers of the dot marks to be marked collectively in such a manner that when dimensions of each of the dot marks in the matrix direction are set to be D1 and D2 respectively, and a gap between the dot marks adjacent in the matrix direction is set to be G, the following equation is satisfied:

P≧{(D1+G)²+(D2+G)²}^{½}

here, G≧0.

According to these aspects of the invention, the distance P between the centers of the dot marks arranged in the matrix direction and an oblique direction with respect to the matrix direction is previously set to satisfy the above equation. This setting includes a method of, when laser beam transmitted through or reflected from the pattern display device pass an optical system, uniformly distributing the respective laser beams corresponding to the dot marks, which pass in accordance with the display patterns of the pattern display device, through the optical system, in such a manner that the distance between the centers satisfies the above equation. As a result, the distributed laser beams are imaged on the marking area of the objective article for being marked.

According to this method, the fusion between the adjacent dot marks is prevented securely, but the design of the optical system becomes extremely complicated, and high accuracy is required for processing. As a result, the producing cost becomes high. Further, since the distance between the adjacent dot marks becomes comparatively larger, a number of the dot marks which can be marked on a limited marking area is limited. As a result, a required amount of information cannot be marked.

According to the present invention, the shape of each dot mark as viewed from it top face is rectangular, square, circular, oval or the like, and their side section includes a hole shape recessed downward from a surface to be marked or a shape protruded from the surface to be marked. It is preferable that a maximum dimension along the surface to be marked is set to be 0.5 to 1.5 μm according to the present invention. As a result, the dot marks with a desired amount of information can be marked on an extremely fine and small area such as a peripheral surface of a wafer, a chamfered portion formed on front and rear surfaces of the wafer or a V-notched inner surface thereof.

Furthermore, according to the present invention, there is provided a feature that makes it possible to mark a pattern composed of dots of the same number and arranged with the same pitch as the conventional ones without being fused to each other, by using the conventional general pattern display device and optical system. Namely, there is provided a laser marking method including steps of: separating the marking pattern into two or more so that the dot marks marked collectively on a marking surface of the objective article for being marked satisfy the above equation; driving pattern display drivers corresponding to the separated patterns independently so as to display the respective separated patterns on the pattern display device successively; and irradiating laser beam for each of the separated patterns displayed on the pattern display device so as to mark a marking pattern composed of dot marks corresponding to the separated patterns on the same marking area of the objective article for being marked.

Furthermore, according to the present invention, there is provided a laser marker suitable for carrying out the laser marking method having the structure as mentioned above. Specifically, the above-described setting means has a pattern separation driving means for separating the pattern display drivers into two or more and driving them independently so as to obtain the marking pattern which satisfies the above equation, and for displaying the respective separated patterns on the display pattern device independently.

Specifically, pattern display drivers, which correspond to dot marks where the distance P between the centers of the dot marks marked collectively on the marking area of the objective article for being marked satisfies the above equation, are extracted from the pattern display drivers composing the display pattern arranged in the same matrix, whereby a first separated pattern is created. Then, pattern display drivers, which correspond to dot marks where the distance P between the centers of the dot marks satisfies the above equation, are extracted from the pattern display drivers other than the pattern display drivers corresponding to the first separated pattern, whereby a second separated pattern is created. Separated patterns thereafter are created by repeating the above operation.

The two or more separated patterns created in this manner are stored in, for example, the storage section of the control unit, and the pattern display device is driven independently based on the stored data. The respective separated patterns are displayed successively on the pattern display device. When laser beam is irradiated onto the display areas at each driving of the pattern display device, an image of the laser beam is imaged in dots on the same marking area of the objective article for being marked via the pattern display device and the optical system. As a result, the dot marks for each separated pattern are marked successively.

Therefore, since the distance P between the centers of the dot marks marked on the same marking area of the objective article for being marked satisfies the above equation at each time of marking, the adjacent dot marks are not fused to each other, and the dot marks are marked accurately without losing a desired shape. When this marking operation is performed successively, a predetermined pattern which is arranged orderly with the same dot gap as in the conventional method can be marked on the matrix that is equal in dimension to the conventional method. At that time, the dot marks composing the respective separated patterns are not overlapped with each other.

Therefore, according to the present invention, the marking pattern composed of collective of the dot marks having required dimensions can be marked accurately even in the limited marking area, without being influenced by heat conduction. Moreover, the dot marks excellent in form can be marked by laser beam with higher energy than that of the conventional one, without requiring any particular cooling time. As a result, the marking time can be shortened. Furthermore, the optical visibility is necessarily improved, so that existence/non-existence of the dots can be read securely.

Meanwhile, according to the present invention, it is preferable that the means for setting the dot mark arrangement satisfying the above equation is the arrangement of the pattern display drivers of the pattern display device, which is different from the conventional one. Namely, since the distance P between the centers of the dot marks satisfies the above equation by using the normal optical system, a pitch between the pattern display drivers of the pattern display device may only be determined in advance such that the distance between the centers at the time of imaging on the marking area of the objective article for being marked satisfies the above equation.

When this method is adopted, it is advantageous when a number of dots required for the marking is small and information is less. However, the gaps between the pattern display drivers arranged on the display area of the pattern display device become extremely larger, and further a number of the dot marks that marked at one time is limited. As a result, the pitch between the dots marks would become larger than being required. Thus, similarly to the dot marking when the above equation is satisfied with the above-mentioned optical system, the marking pattern is limited in the same marking area, so that it is impossible to mark a required amount of information, and discrimination of the patterns is difficult.

The objective article for being marked to be processed according to the present invention includes a semiconductor wafer, a glass substrate such as a liquid crystal substrate, an electrode (pad) such as a bare chip, an IC surface, various ceramic products, a lead section of IC or the like.

As the pattern display device, there is provided a liquid crystal mask as a transmission-type liquid crystal device, in which liquid crystals as pattern display drivers that can arbitrarily control and drive transmission/non-transmission of beam for each liquid crystal based on various data written into the control unit, are arranged in a matrix. Moreover, as another pattern display device, a beam homogenizer may be adopted. The beam homogenizer may have a system for collectively irradiating a mask surface using, for example, a fly eye lens, a binary optics or a cylindrical lens, or a system for driving a mirror by means of an actuator such as a polygon mirror or a mirror scanner so as to beam-operate the mask surface. Further, instead of the liquid crystal mask, a multi-mirror module or an acoust-optic element may be adopted.

### BRIEF DESCRIPTION OF THE DRAWINGS

FIG. 1 is an explanatory diagram for setting a distance between centers of dot marks required for forming a required display pattern by means of a laser marker of the present invention.

FIG. 2 is an explanatory diagram showing an arrangement area of dot marks which is allowed at the time of marking by means of the laser marker of the present invention.

FIGS. 3A to 3C are explanatory diagrams showing typical embodiments of a marking method of the present invention.

FIGS. 4A to 4D are explanatory diagrams showing concrete embodiments of the marking methods of the present invention.

FIG. 5 is a flowchart of the embodiment.

FIG. 6 is a data diagram showing changes in heights of the dot marks, which are formed by the method of the present invention and a conventional one, with respect to changes in energy density of laser beam.

FIG. 7 is an imaged photograph showing dot shapes according to the method of the present invention when the energy density of the laser beam is 6 (J/cm²).

FIG. 8 is an imaged photograph showing dot shapes according to the conventional method under the same condition as above.

FIG. 9 is an imaged photograph showing dot shapes according to the method of the present invention when the energy density of the laser beam is 8 (J/cm²).

FIG. 10 is an imaged photograph showing dot shapes according to the conventional method under the same condition as above.

FIG. 11 is a schematic structural diagram showing an example of a general laser marker.

FIG. 12 is a schematic structural diagram showing another example of a general laser marker.

FIG. 13 is a schematic structural diagram showing still another example of a general laser marker.

FIGS. 14A to 14D are explanatory diagrams showing examples of shapes of display pattern formed on a liquid crystal mask of the laser marker.

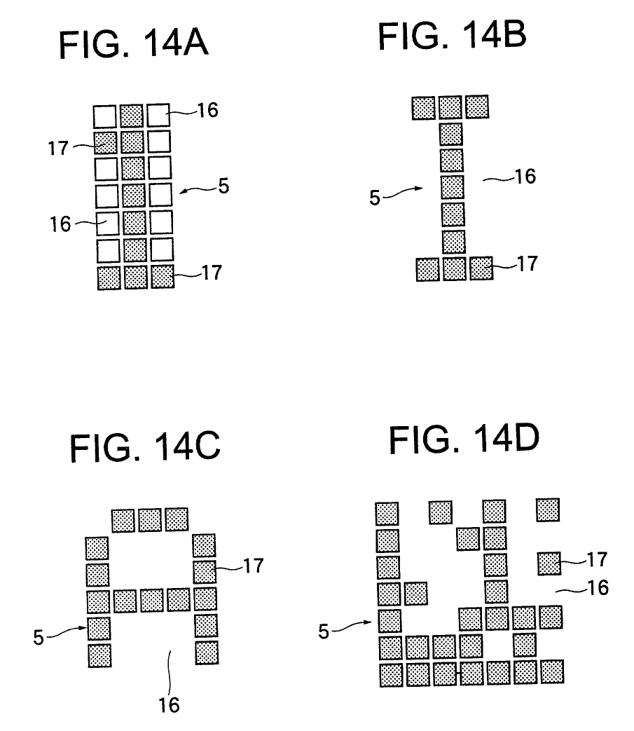

FIG. 15 is an explanatory diagram showing a marking pattern formed according to the display pattern of the liquid crystal mask.

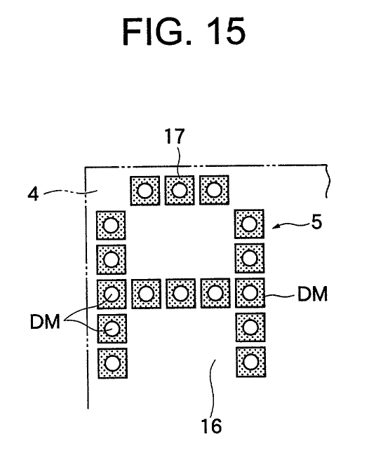

FIGS. 16A to 16D are explanatory diagrams showing examples of improper forms of a marking pattern formed according to a required display pattern to be marked in a conventional laser marker.

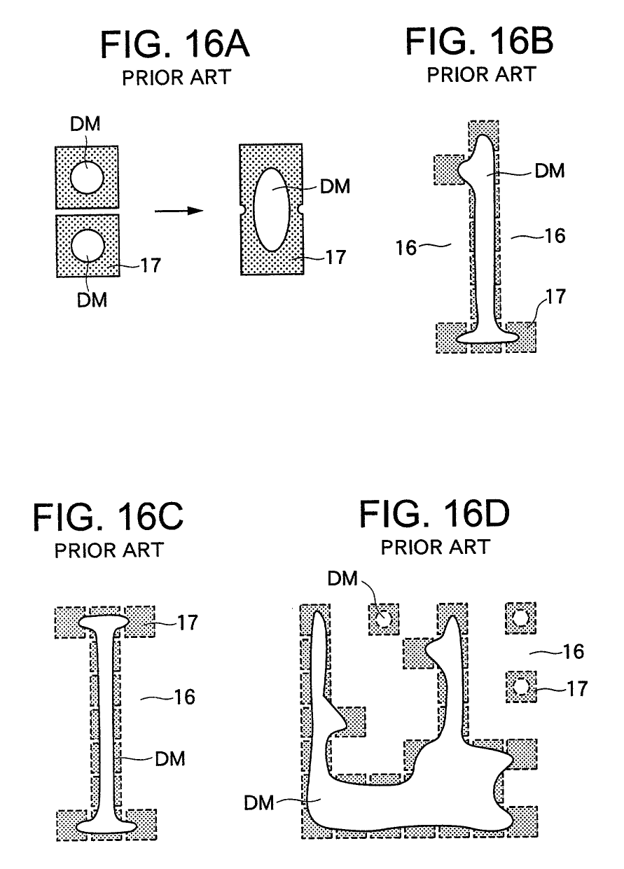

### DESCRIPTION OF THE EMBODIMENTS

Embodiments of the present invention will now be described in detail with reference to attached drawings.

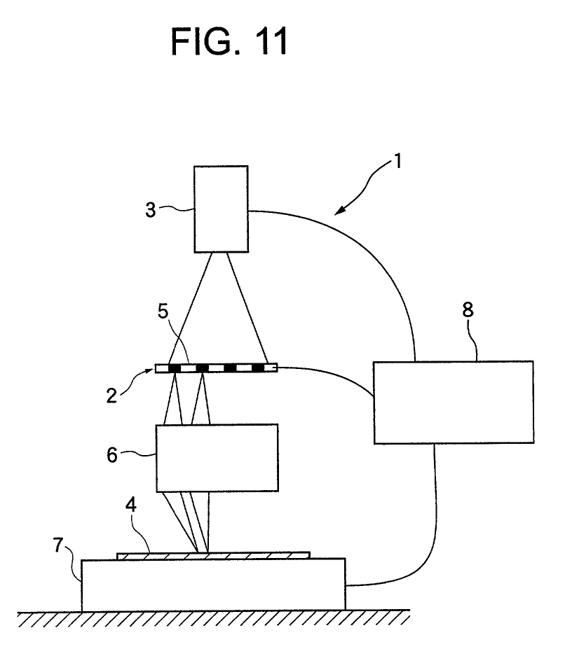

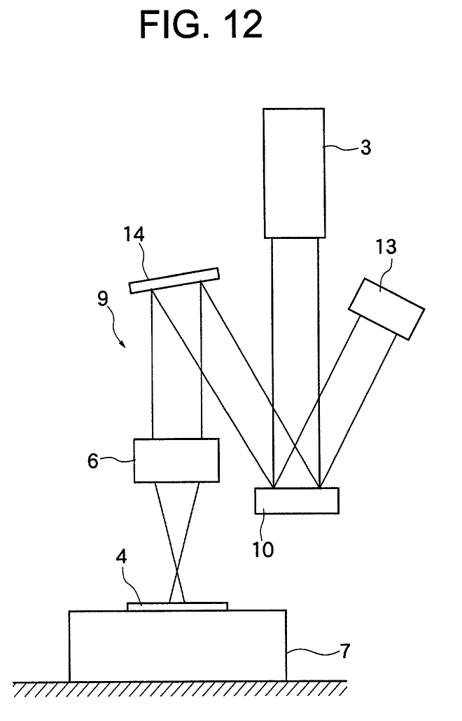

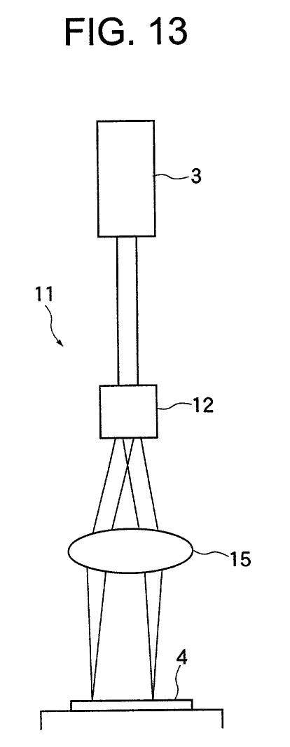

General laser markers as shown in FIGS. 11 to 13 can be applied to the present invention.

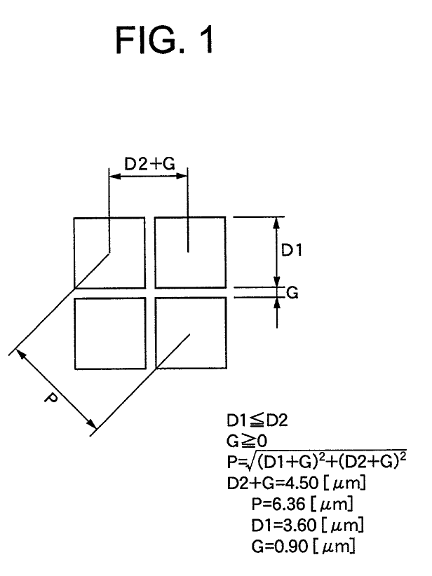

Here, the embodiments of the present invention will be explained based on FIGS. 1 to 7 with reference to the laser marker as shown in FIG. 11 that uses liquid crystal mask as a display device. In FIGS. 1 to 7, the same reference numerals as those of FIGS. 11 to 13 are given to the components that are the same as those in the conventional technique.

As shown in FIG. 11, a laser marker 1 applies an YAG laser oscillator 3 as a light source and marks a required marking pattern composed of many dot marks such as characters, symbols and numbers on a surface of an objective article 4, which is to be marked with the marking pattern, carried by a carrier device 7. Laser beam from the laser oscillator 3 is irradiated onto an irradiation area of a liquid crystal mask 2 serving as a pattern display device on which a required display pattern to be marked is driven to be displayed via an optical member such as a collimator lens or a polygon mirror (not shown). The required display pattern to be marked is divided into at least two different separated patterns A and B, and these two different separated patterns A and B are driven to be displayed successively on the liquid crystal mask 2 independently.

The laser beam transmitted through the liquid crystal mask 2 is irradiated onto the same surface of the objective article 4 for being marked via a lens unit 6 imaging each of the dots that have transmitted through the liquid crystal mask 2. In the present embodiment, required marking patterns corresponding to the two or more separated patterns are marked successively on the same surface of the article 4 for being marked.

In these operations, a control unit 8 which follows an instruction of a main program of a computer system (not shown) controls laser oscillation of the laser oscillator 3, and the laser irradiation is driven and controlled by the optical member (not shown) and the lens unit 6. The control unit 8 drives and controls liquid crystals as transmissible pattern display drivers and the two or more separated patterns independently, and further drives the carrier device 7 and the other for the objective article 4 for being marked. The liquid crystals are arranged in a matrix on the irradiation area of the liquid crystal mask 2. Arbitrary liquid crystals are driven and displayed in accordance with the instructions of the control unit 8. The liquid crystal mask 2 applies a voltage according to a required display pattern to respective element electrodes of each liquid crystal unit.

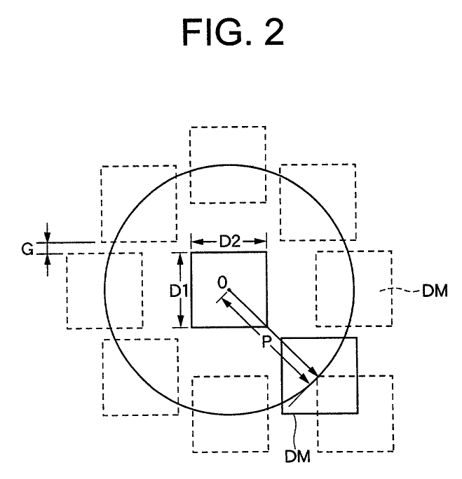

The most important point of the present invention is in how a distance between centers of dot marks to be marked on the surface of the objective article 4 for being marked is set. FIGS. 1 and 2 are explanatory diagrams showing a method of setting a distance P of centers of dot marks and their arrangement.

In FIG. 1, DM indicates rectangular dot marks as viewed from their top faces. When a dimension of a file direction is D1, and a rank direction is D2, and a gap between the dot marks DM is G, the distance P between centers of all the dot marks DM adjacent in an oblique direction is set according to the following equation:

P≧{(D1+G)²+(D2+G)²}^{½}

here, G≧0.

According to this relation of the equation, a shape of the dot mark DM as viewed from its top face may be a square, a circular, an oval or the like. Thus, this is not limited to a particular shape. Moreover, the whole shape of the dot marks DM may be a concave hole shape or a protruded shape. The factor that determines this shape is frequency of laser beam, energy density and the like as will be described later.

Furthermore, in a concrete embodiment of the present invention as will be mentioned below, an entire marking pattern is to be divided into two or more parts and the dot marks DM are marked successively whereby a marking pattern composed of the dot marks DM arranged as required is obtained. However, in the present invention, as mentioned above, a number of dot marks to be marked on a marking surface may be small. In this case, only if the liquid crystal mask is arranged in such a manner that, after the laser beam passes through the lens unit 6, the distance P between the centers of the dots to be imaged on the marking area of the objective article for being marked satisfies the above equation, for example, the marking can be occasionally ended with one-time marking operation.

If the arrangement of the dot marks wherein the distance P between the centers of the dot marks satisfies the above equation is such that, as shown in FIG. 2, adjacent dot marks DM are arranged on a circumference where its radius extended from a center O of an arbitrary dot mark DM is {(D1+G)²+(D2+G)²}^{½} or more, the adjacent dot marks DM are prevented from fused to each other by the marking operation.

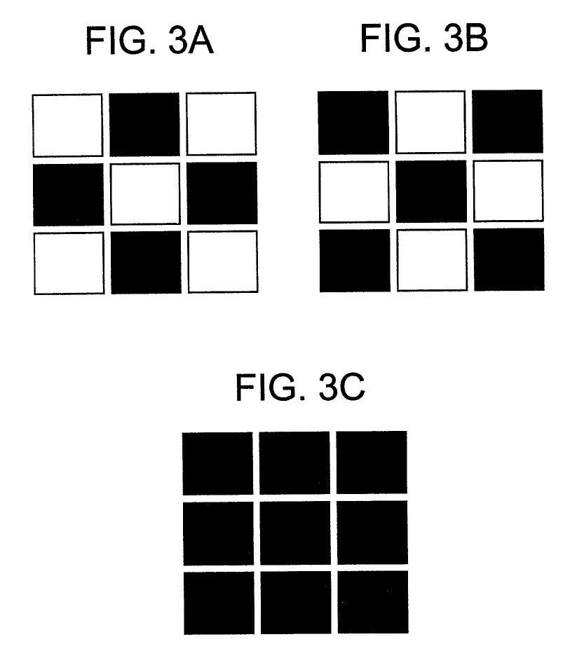

FIG. 3A to 3C show examples of a typical embodiment of the present invention. FIG. 3C schematically shows an entire marking pattern in which three dot marks are arranged in the matrix direction so that nine (3×3) dot marks DM are arranged in a matrix. Specifically, in the present embodiment, three liquid crystals of the liquid crystal masks 2, namely, nine liquid crystals of the liquid crystal masks 2 in total are arranged in a matrix, and the control unit 8 drives arbitrary liquid crystals among them independently so that an arbitrary pattern can be displayed.

Here, in the present embodiment, the control unit 8 has a storage section which is capable of storing addresses of the liquid crystals in the liquid crystal mask 2. The addresses are stored in such a manner that the addresses are divided for separated patterns A and B composed of two sets of liquid crystal groups being staggered as shown in FIGS. 3A and 3B so as not to be overlapped with each other. Moreover, the control unit 8 has pattern separation driving means for driving the separated patterns A and B individually.

Furthermore, the control unit 8 has pattern converting means that extracts liquid crystals required for displaying and driving the liquid crystals arranged in the two or more divided patterns and converts them into a new converting pattern. The detailed description thereof was introduced in the specification of the Japanese patent Application Publication No. 10-188712 by the applicants of the present invention. Thus, the descriptions thereof are omitted here.

The control unit 8 reads out the two separated patterns from the storage section independently, and drives them successively and independently by means of the pattern separation driving means. Specifically, firstly, liquid crystals corresponding to the separated pattern A of FIG. 3A are driven to be displayed independently on the display area of the liquid crystal mask 2. After this display, the laser oscillator 3 is driven to irradiate laser beam onto the display area of the liquid crystal mask 2, and then the laser beam is transmitted through the liquid crystals 17 corresponding to the displayed separated pattern. The separated pattern A is allowed to pass through the lens unit 6 and is reduced so as to be imaged on the marking surface of the objective article 4 for being marked. As a result, the separated pattern A is marked. At this time, all the distances P between the centers of the dot marks DM adjacent in an oblique direction, which are simultaneously marked on the marking surface of the objective article 4 for being marked, satisfy the above equation. Therefore, the dot marks DM are not fused to each other, and the dot marks DM are arranged orderly while maintaining predetermined shapes.

Next, the driving of the pattern separation driving means is switched to drive liquid crystals corresponding to the other separated pattern B as shown in FIG. 3B independently and successively. Laser beam from the laser oscillator 3 is irradiated onto the separated pattern B displayed on the same display area of the liquid crystal mask 2, and another marking pattern corresponding to the separated pattern B is imaged on the same marking surface of the objective article 4 via the lens unit 6 and then marked thereon successively.

The dot marks DM composing the separated pattern B to be marked at this time are marked on gap areas adjacent to the dot marks DM composing the separated pattern A as shown in FIG. 3A that have been marked previously. Therefore, the previously marked dot marks DM are hardly affected by thermal energy and fusion due to the subsequent formation of dots does not occur, so that all the required marking patterns can be formed orderly.

This can be applied to a case where a marking area is extremely narrow and fine dot marks are marked. Specifically, adjacent dot marks are not influenced by heat conduction, and required marking patterns can be marked accurately on a matrix having the same dimension as that of the conventional art. Furthermore, since the marking with laser beam having a desired energy can be carried out without requiring any particular cooling time, the marking time can be shortened.

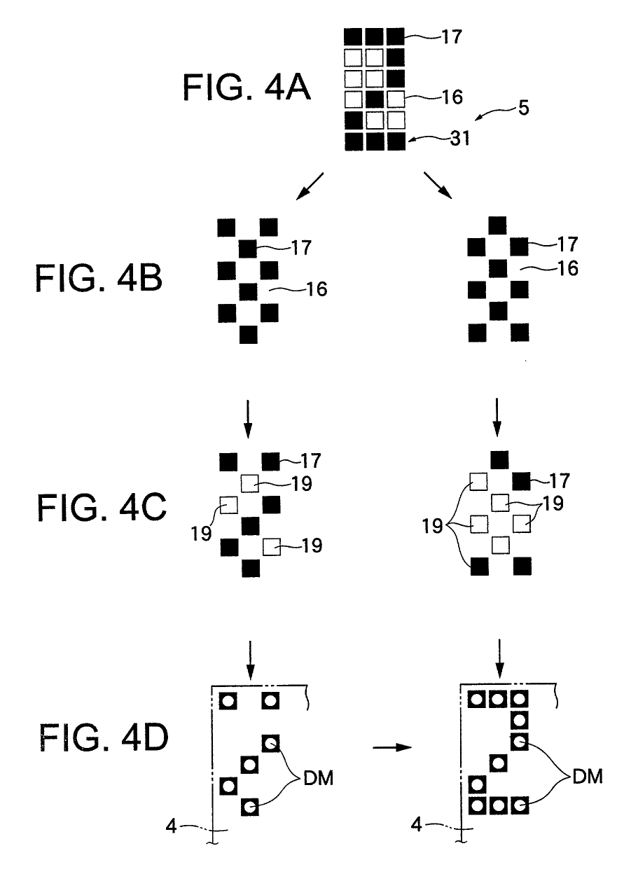

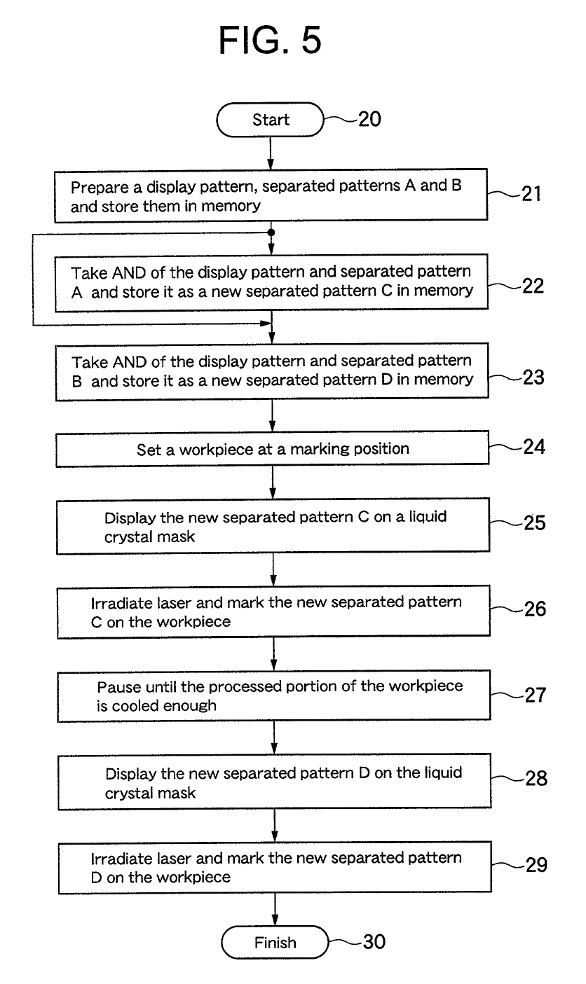

FIGS. 4 and 5 show a general marking procedure for marking patterns to be formed according to a required displayed pattern to be marked in the laser marker of the present invention and its flowchart. At first, a display pattern 5 (whole pattern 5) to be marked on a surface (a marking surface) of the objective article 4 for being marked, the separated patterns A and B are selected by a microcomputer (not shown). This selection can be carried out by an external operation. The whole pattern 5 and the respective separated patterns A and B are stored in an internal storage section of the control unit 8 (block 21).

Next, in a block 22, the separated pattern A and the required display pattern 5 to be marked are read out independently from the internal memory of the control unit 8, and the separated pattern A is compared with the required display pattern 5. Then, the separated pattern A is converted into a new separated pattern C based on the required display pattern 5 to be marked on the liquid crystal mask 2. The new separated pattern C is stored in the internal memory of the control unit 8.

Further, in a block 23, the other separated pattern B and the required display pattern 5 to be marked are read out independently from the internal memory of the control unit 8, and the separated pattern B is compared with the required display pattern 5. Then, the separated pattern B is converted into a new separated pattern D based on the required display pattern 5 to be marked. The new converted pattern D is stored in the internal memory of the control unit 8.

Next, in a block 24, the objective article 4 for being marked is conveyed by the carrier device 7 based on the instructions of the control unit 8 to be set in a marking position. The optical elements or the like such as a deflection mirror or a moving lens (not shown) are controlled to be positioned by the control unit 8.

Next, in a block 25, the converted pattern C read out independently from the internal memory of the control unit 8 is driven and displayed (dot-displayed) independently on the irradiation area of the liquid crystal mask 2, and the sequence goes to a block 26. In the block 26, the display area of the liquid crystal mask 2 is batch-irradiated or scanned with laser beam. The laser beam transmitted through the liquid crystal mask 2 is imaged on the surface of the objective article 4 for being marked via the lens unit 6, and the separated pattern C is marked. Then, the sequence goes to a block 27. In the block 27, a predetermined time is taken for lowering temperature of a processed portion of the objective article 4 for being marked. After the predetermined time has passed, the sequence goes to a block 28.

In the block 28, the other converted pattern D read out independently from the internal memory of the control unit 8 is displayed in dots independently on the same display area of the liquid crystal mask 2, and the sequence goes to a block 29. In the block 29, the irradiation area of the liquid crystal mask 2 is batch-irradiated or scanned with laser beam, whereby the separated pattern D is marked on the surface of the objective article 4 for being marked via the lens unit 6. As a result, the new separated patterns C and D are marked successively, and a finally required marking pattern is synthesized on the same marking surface of the objective article 4 for being marked. Thus, the whole marking is completed.

In the above-mentioned process, the description was given to the case where the liquid crystals corresponding to the new separated patterns C and D to be marked are used to carry out the marking. In the case where, as shown in FIG. 3, the separated patterns A and B set at first are used to mark the whole marking pattern, on the other hand, the sequence starts in the block 20 and goes from the block 21 to the block 24, then from the block 24 to the block 29, and is completed in the block 30.

Here, in the present embodiment, the irradiation area of the liquid crystal mask 2 which can be irradiated at one time can accommodate for a number of dots: 5×10 to 10×10. This area is batch-irradiated with laser beam, but such a number of dots is frequently insufficient for all the number of dot marks. Therefore, a plurality of display patterns of required size are divided into several sections, and the liquid crystal mask 2 is displayed for each of the divided patterns, whereby the two or more separated patterns are driven successively and independently to form a whole marking pattern successively on the surface of the objective article for being marked.

Furthermore, the above embodiment was explained based on a transmission type liquid crystal device as the pattern display device, but a multi-mirror module or an acoust-optic element may be used. As the optical member, for example, a fly eye lens, a binary optics or a cylindrical lens may be used for batch-irradiate the mask surface thereof with laser beam, or to scan the mask surface by mirror driving by means of an actuator such as a polygon mirror or a mirror scanner. The objective article for being marked as an object to be processed according to the present invention may include a semiconductor wafer, a glass substrate such as a liquid crystal substrate, an electrode (pad) such as a bare chip, an IC surface, various ceramic products, a lead section of IC and the like.

### (Example and Comparative Example)

Next, an example of the present invention with a comparative example will now be described in detail with reference to the drawings.

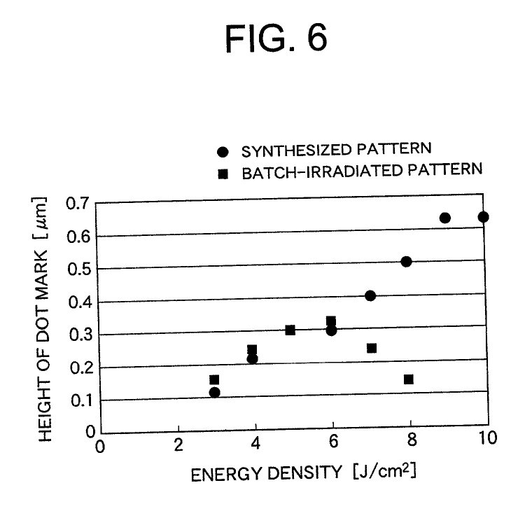

FIG. 6 shows a state of a change in a dot mark height (μm) based on the dot marking of the present invention and the conventional dot making when the laser marker having a basic structure as shown in FIG. 11 is used and the energy density of laser beam is varied in six ways of 3, 4, 6, 8, 9 and 10 (J/cm²). In these examples, the shape of each dot mark is set to be a square as viewed from its top surface, in which a length of one side is 3.6 μm (D1=D2), and a gap G between the dot marks in the matrix direction is 0.9 μm.

In the drawing, plots “●” show results of the present embodiment of the present invention based on the above embodiment shown in FIG. 3 where the separated patterns are synthesized, and plots “▪” show results in the conventional case where a whole required pattern is marked by batch irradiation of laser beam. The other marking conditions in both the cases are the same, and the both cases include a dot mark having such a shape that its center portion protrudes the marking surface.

It can be understood from the diagram that as the energy density of laser beam increases, the height of the dot marks increases approximately linearly in the present invention. On the contrary, in the conventional case where a whole marking pattern is marked with one-time marking operation, as the energy density of the laser beam increased, the height of dot marks became maximum when the energy density increases to 6 (J/cm²) but gets less thereafter. In other words, when a dot mark having a protruded center portion is marked according to the conventional method, the protruded portion gets much influenced by the energy density. When the energy density exceeds a certain value, adjacent dot marks are fused to each other. Thus, almost all the protrusion of the protruded portion is eliminated.

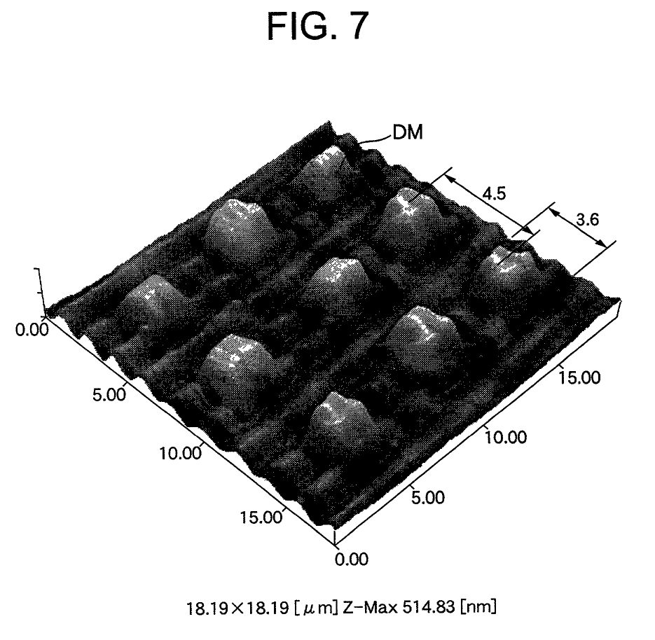

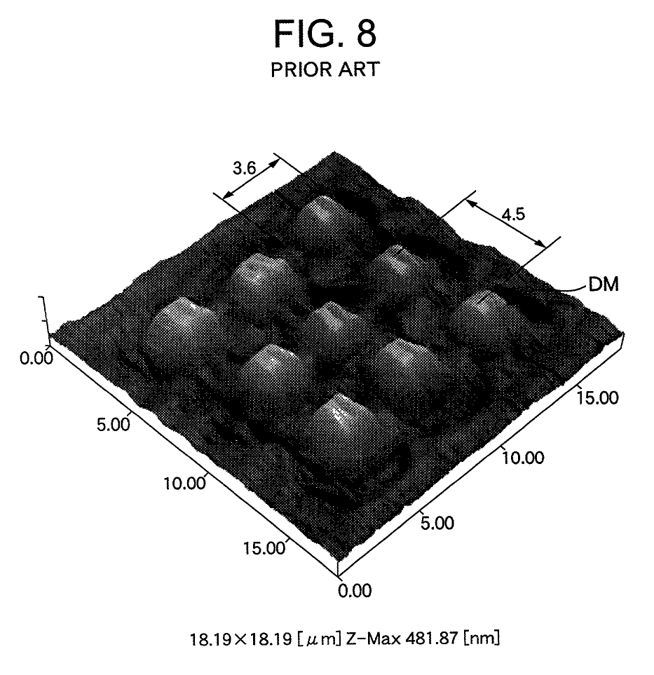

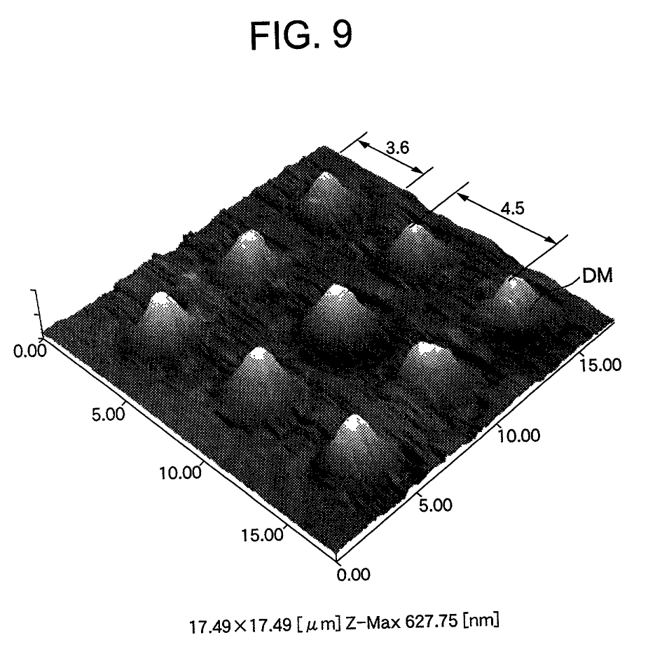

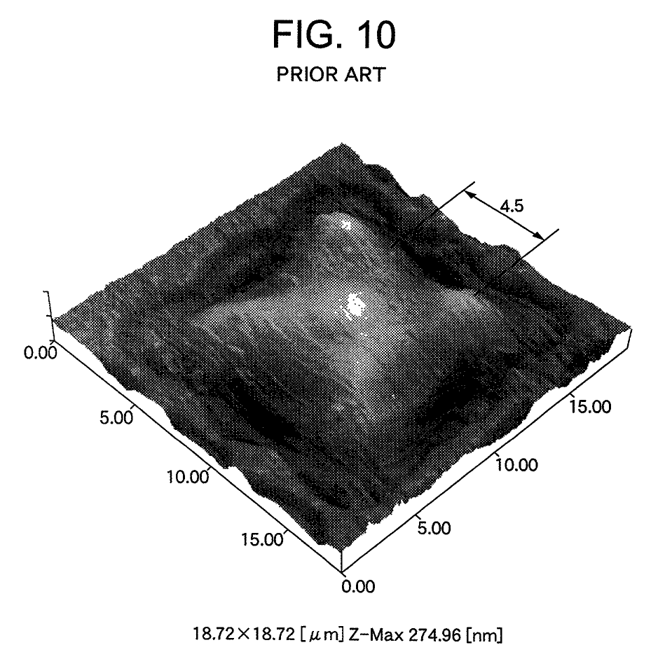

FIGS. 7 to 10 are imaged photographs showing difference in the shows of the dot marks when the energy density is set to be 6 and 8 (J/cm²) in the above-mentioned examples of the present invention and the conventional examples. FIGS. 7 and 8 show the shapes of the dot marks marked according to the above examples of the present invention and the conventional example when the energy density is 6 (J/cm²). FIGS. 9 and 10 show the shapes of the dot marks marked according to the above examples of the present invention and the conventional example when the energy density is 8 (J/cm²).

As understood from these photographs, particularly when the energy density is set to be 8 (J/cm²), the dot mark formed by the method of the present invention has a shape of an approximately square pyramid, and the dot marks are arranged in the matrix direction orderly. Therefore, the visibility is secured optically. On the contrary, the dot marks formed by the conventional method have no dot shapes, namely, all the dot marks are completely fused to each other, so that the visibility cannot be secured.

In the present embodiment and the conventional example, protruded dot marks are formed. However, when the energy density further increases, for example, concave hole-shaped dot marks can be formed. Also in this case, the respective dot marks can be formed orderly according to the marking method of the present invention, while in the conventional method, adjacent dot marks are fused to each other and a depth of the holes becomes shallow, so that the marks cannot be visualized optically.

As is clear from the above description, in the laser marker and the marking method of the present invention, when the distance between the centers of the adjacent dot marks formed on the marking area of the objective article for being marked is set to satisfy the above-described equation, the dot marks can be marked accurately and orderly regardless of the size of the dot marks. Moreover, the dot marks can be marked by laser beam having desirable energy. As a result, the marking time can be shortened. Furthermore, even if the dot marks are fine, the optical visibility is improved so that the dot marks can be read accurately. The present invention should not be limited to the above embodiments/examples and, needless to say, includes the technical scope where the person skilled in the art can easily make modifications.

What is claimed is:

1. A laser marking method of marking a required marking pattern on a surface of an objective article for being marked by means of a laser marker, including a step of setting a distance P between centers of dot marks to be marked collectively such that, when dimensions of each of the dot marks in a matrix direction are set to be D1 and D2 respectively, and a gap between the dot marks adjacent in the matrix direction is set to be G, the following equation is satisfied:
P≧{(D1+G)²+(D2+G)²}^{½}
here, G≧0.

2. A laser marking method according to claim 1, wherein the dimensions D1 and D2 of each of the dot marks in the matrix direction are set to be 0.5 to 15 μm.

3. A laser marking method according to claim 1, further including steps of:
separating the marking pattern into two or more such that the dot marks marked collectively on a marking surface of the objective article for being marked satisfy the above equation;
driving pattern display drivers corresponding to the separated patterns independently so as to display the separated patterns on a pattern display device successively; and
irradiating laser beam for each separated pattern displayed on the pattern display device so as to mark the marking pattern composed of dot marks corresponding to the separated patterns on the marking area of the objective article for being marked.

4. A laser marker for driving a plurality of pattern display drivers, irradiating laser beam onto a display area of a pattern display device on which a desired display pattern is displayed and spot-irradiating the laser beam onto a marking area of an objective article for being marked via said pattern display device and an optical system so that a desired marking pattern is marked with a plurality of dot marks arranged in a matrix direction, said laser marker including:
setting means for setting a distance P between centers of the dot marks to be marked collectively such that, when dimensions of each of the dot marks in the matrix direction are set to be D1 and D2 respectively, and a gap between the dot marks adjacent in the matrix direction is set to be G, the following equation is satisfied:
P≧{(D1+G)²+(D2+G)²}^{½}
here, G≧0.

5. A laser marker according to claim 4, wherein said setting means is in arrangement of the pattern display drivers of said pattern display device.

6. A laser marker according to claim 4, wherein said setting means has pattern separation driving means for separating the pattern display drivers into two or more and driving them independently such that the marking pattern which satisfies the above equation is obtained, and for displaying the respective separated patterns on said pattern display device independently.
